(19) United States
(12) Patent Application Publication
(10) Pub. No.: US 2011/0218891 A1
(43) Pub. Date: Sep. 8, 2011

(54) DISPLAYING PREPAID ACCOUNT INFORMATION AT MOBILE STATION

(75) Inventors: Helen SJELVGREN, Brakne-Hoby (SE); Robert Törnkvist, Karlshamn (SE)

(73) Assignee: TELEFONAKTIEBOLAGET LM ERICSSON (PUBL), Stockholm (SE)

(21) Appl. No.: 12/715,782

(22) Filed: Mar. 2, 2010

(51) Int. Cl. G06Q 10/00; G06F 3/048; G06Q 40/00

(52) U.S. Cl. 705/30; 715/771

(57) ABSTRACT

A prepaid mobile station (30) comprises a communications unit (49) and a display unit (52). The communications unit (49) is configured to participate in transmission of data over a radio interface (32) on a prepaid account basis. The display unit is configured to provide a unique prepaid account graphical depictor (54, 54′). The prepaid account graphical depictor (54, 54′) provides a visual indication of a prepaid account balance value for a prepaid account in scaled relation to a boundary value. The boundary value is other than and less than a maximum allowed prepaid account value and can be, for example, a latest refill value for the prepaid account; an account status/balance at refill occasion value for the prepaid account; or a configured value for the prepaid account.

### BACKGROUND

This invention pertains to telecommunications, and particularly to the provision and/or display of prepaid account information at a mobile station.

Some communication (e.g., telephony) service providers and/or network operators have arrangements or contracts which permit some mobile stations (e.g., cell phones or other types of wireless terminals) to operate on a prepayment basis. The users of such mobile stations have a “prepaid” account with the service provider or operator. For such prepaid account the user essentially pays for service in advance (either by credit card, funds transfer, or otherwise). The user must maintain and replenished the account in order for the mobile station to participate in or utilize the services and/or infrastructure of the provider or network.

For sake of management and financial administration the service provider or network operator typically maintains or has access to an electronic accounting system. The electronic accounting system can comprise one or more nodes or service points included in or connected to an operator's network (e.g., a core network, for example). The electronic accounting system essentially maintains an accounting ledger or the like for each prepaid account and/or prepaid mobile station user. The ledger can have an associated set of rules such as, for example, a rule that the mobile station that operates on a prepaid basis is not to be granted service until and unless a specified account minimum financial balance (e.g., a financial amount greater than zero) is achieved. The prepaid account can receive a deposit or be replenished, in which case the ledger amount for the prepaid account is increased. Conversely, when the prepaid mobile station utilizes service(s) of the network/operator, the electronic accounting system can receive call detail reports or other communications which cause the ledger amount of the prepaid account to be debited, e.g., in accordance with the nature and/or extent of such service(s).

It is prudent and advantageous for the user of a mobile station which operates on a prepaid account basis (a “prepaid mobile station”) to be well advised regarding the financial status of the user's prepaid account. For example, correct awareness of the financial condition of the prepaid account enables the user to make calls and utilize service(s) with relative certainty of network acceptance, and in addition affords the user better opportunity for financial planning. Moreover, the users being appropriately apprised of the prepaid account status generally results in the service provider/operator receiving more timely income as the accounts are replenished.

Consumers/users of prepaid mobile station can obtain their prepaid account information in various ways. Some examples are obtaining prepaid account information on line via Internet, through Wireless Application Protocol (WAP) portals, by sending Unstructured Supplemental Service Data (USSD) requests, or calling a customer support office or the like.

In some telephony operating environments a prepaid mobile station is provided with prepaid account information in the form of a text message or the like which is sent over the radio interface to the mobile station. For example, a text message may be delivered in conjunction with a completed call or some other event, e.g., an event which is periodic or user/network driven/generated. The text message provides an account balance in alphanumeric form. Alternatively or additionally, the consumer/user can use the prepaid mobile station itself to obtain certain prepaid account information from the network, e.g., by calling a special number or entering a special code which results in alphanumeric display of a prepaid account balance, for example.

Some consumers/users do not appreciate wireless reception of unsolicited prepaid account information, particularly at inconvenient times. Moreover, when the prepaid account information is wanted, some of the vehicles for obtaining the prepaid account information are time consuming or not user-friendly in various ways.

### SUMMARY

In one of its varied aspects the technology disclosed herein concerns a prepaid mobile station. The prepaid mobile station comprises a communications unit and a display unit. The communications unit is configured to participate in transmission of data over a radio interface on a prepaid account basis. The display unit is configured to provide a unique prepaid account graphical depictor. The prepaid account graphical depictor provides a visual indication of a prepaid account balance value for a prepaid account in scaled relation to a boundary value. The boundary value is other than and less than a maximum allowed prepaid account value and can be, for example, a latest refill value for the prepaid account; an account status/balance at refill occasion value for the prepaid account; or a configured value for the prepaid account.

In an example embodiment the depictor comprises a perimeter-bounded graphical construct. A perimeter of the perimeter-bounded graphical construct represents the boundary value. The perimeter-bounded graphical construct is at least partially graphically internally filled by a first graphical figure. An extent of filling of the perimeter-bounded graphical construct by the first graphical figure being is in proportion to a ratio of the prepaid account balance value to the boundary value.

In another example embodiment, the perimeter-bounded graphical construct is also at least partially graphically internally filled by a second graphical figure. An extent of filling of the perimeter-bounded graphical construct by the second graphical figure is in proportion to a ratio of an unexpired time value to a total time value associated with the prepaid account.

In an example implementation the prepaid mobile station comprises a prepaid logic unit. The prepaid logic unit in turn comprises a report processor and a boundary value selector. The report processor is arranged to receive and/or use a graphical parameter which expresses a relation of the prepaid account balance to the boundary value. Display of the prepaid account graphical depictor on the display unit is dependent on the graphical parameter. The boundary value selector is arranged to prepare a directive message for the charging system. The directive message is prepared or formatted to specify one of plural candidate value types to be used (e.g., in the report by the charging system) for preparing the graphical parameter. The plural candidate value types include a latest refill value for the prepaid account; an account status/balance at refill occasion value for the prepaid account; and a configured value for the prepaid account.

In an example implementation, the display unit is also configured to provide an alphanumeric representation of the prepaid account balance value when user interaction occurs proximate the prepaid account graphical depictor.

In another of its aspects the technology disclosed herein concerns a charging unit which manages financial transactions for a prepaid mobile station. In an example embodiment the charging unit comprises an account ledger and a prepaid account report generator. The account ledger maintains a prepaid account balance value for a prepaid account for the prepaid mobile station. The prepaid account report generator can be configured to provide the prepaid mobile station with a graphical parameter. The graphical parameter (which can be supplied by the charging system or maintained at the mobile station) is configured to express a relation of the prepaid account balance to a boundary value to enable the prepaid mobile station to generate a prepaid account graphical depictor on a display of the prepaid mobile station so that the prepaid account graphical depictor illustrates the prepaid account balance value in scaled relation to the boundary value. The boundary value is other than and less than a maximum allowed prepaid account value for the prepaid mobile station.

In example embodiments, which can be alternative, the boundary value represents either a latest refill value for the prepaid account; an account status/balance at refill occasion value for the prepaid account; or a configured value for the prepaid account.

In an example implementation, the prepaid account report generator is configured to select between one of plural candidate value types to be used in the report by the charging system for the boundary value. The plural candidate value types include a latest refill value for the prepaid account; an account status/balance at refill occasion value for the prepaid account; and a configured value for the prepaid account. In an example implementation, the prepaid account report generator is configured to select between one of plural candidate value types on the basis of a directive message received from the prepaid mobile station.

In an example embodiment the prepaid account report generator is further configured to provide the prepaid mobile station with a time parameter. The time parameter is configured whereby the prepaid mobile station can also use the prepaid account graphical depictor to express a relation of an unexpired time value for the prepaid account to a total time value associated with the prepaid account.

In another of its aspects the technology disclosed herein concerns a method of managing a prepaid account for a prepaid mobile station. In an example embodiment and mode the method comprises an act of providing to the prepaid mobile station with a graphical parameter configured to express a relation of a prepaid account balance for the prepaid account for the prepaid mobile station to a boundary value. In some embodiments the graphical parameter can be provided to the prepaid mobile station by a charging system (external to the prepaid mobile station) over the air interface. The method further comprises the prepaid mobile station receiving and using the graphical parameter to generate a prepaid account graphical depictor on a display of the prepaid mobile station so that the prepaid account graphical depictor illustrates the prepaid account balance value in scaled relation to the boundary value. The boundary value is other than and less than a maximum allowed prepaid account value for the prepaid mobile station. In various embodiments, which can be alternative, the boundary value represents a latest refill value for the prepaid account; an account status/balance at refill occasion value for the prepaid account; or a configured value for the prepaid account.

In an example embodiment and mode the method further comprises specifying one of plural candidate value types to be used for preparing the graphical parameter. The plural candidate value types can include a latest refill value for the prepaid account; an account status/balance at refill occasion value for the prepaid account; and a configured value for the prepaid account.

In an example embodiment and mode, the method further comprises providing the prepaid mobile station with a time parameter. The time parameter is configured whereby the prepaid account graphical depictor can also be used to express a relation of an unexpired time value for the prepaid account to a total time value associated with the prepaid account.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a schematic view of a communications system comprising a prepaid mobile station having a prepaid account managed by a charging system.

FIG. 2 is a diagrammatic view of an example embodiment of a prepaid mobile station and showing a prepaid account graphical depictor provided on a visual display unit of the prepaid mobile station.

FIG. 3 is an enlarged diagrammatic view of the prepaid account graphical depictor of FIG. 2.

FIG. 4 is a schematic view of a communications system comprising a prepaid mobile station having a prepaid account logic unit.

FIG. 5 is a diagrammatic view depicting refill of a prepaid account and generation by a charging system of a scaled prepaid account report for transmission to and display by a prepaid mobile station.

FIG. 6 is a schematic view of a communications system comprising a prepaid mobile station from which a customer or user can select which of plural possible boundary values is to actually be used for a boundary value for a prepaid account graphical depictor.

FIG. 7 is a schematic view of a communications system comprising a prepaid mobile station having a prepaid account graphical depictor capable of additionally indicating time usage for a prepaid account that has a time limit.

FIG. 8 is a diagrammatic view of an example embodiment of a prepaid mobile station and showing a prepaid account graphical depictor which is provided on a visual display unit of the prepaid mobile station and enhanced to provide the time usage for the embodiment of FIG. 7.

FIG. 9 is an enlarged diagrammatic view of the enhanced prepaid account graphical depictor of FIG. 8.

FIG. 10 is a schematic view showing more structural detail for certain example embodiments of a charging system and a prepaid mobile station.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its spirit and scope. In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

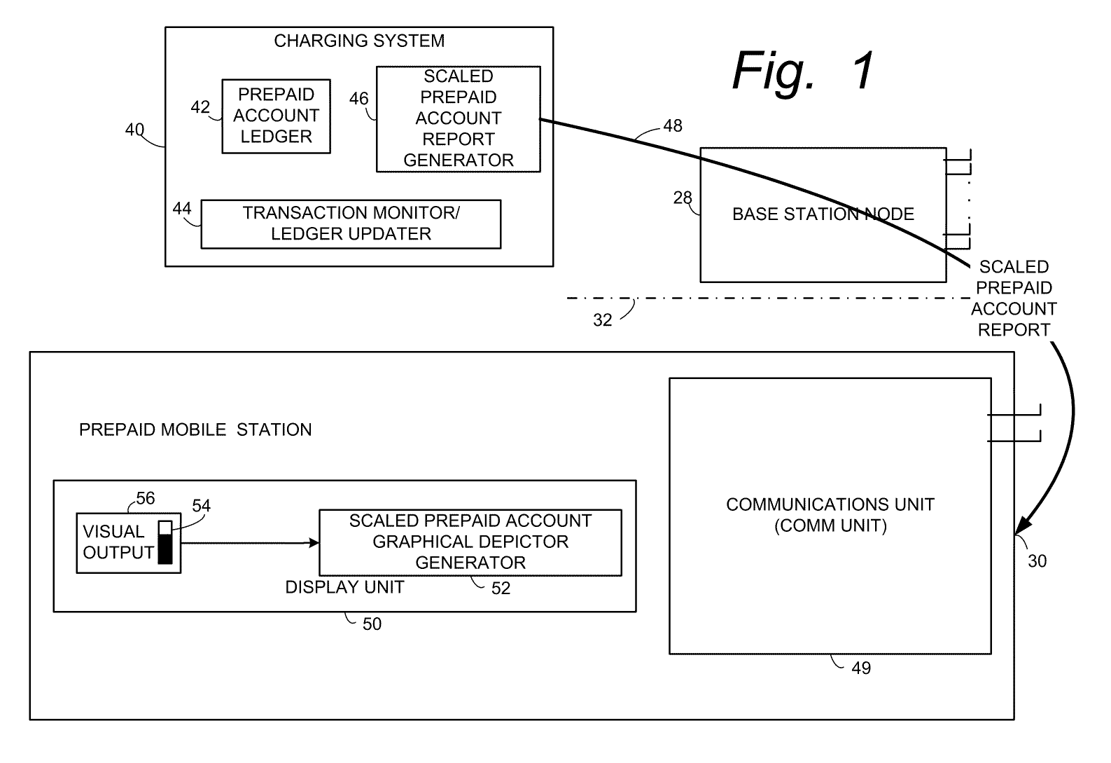

FIG. 1 shows an example communications or telephony network wherein base station node 28 communicates with mobile station 30 over air or radio interface 32 (e.g., a Uu interface). The terminology “base station node” is intended to refer to any radio access network node which has essentially direct contact over the radio or air interface with wireless units, and can also be denominated as radio base station, NodeB, eNodeB, and the like in accordance with the particular version or radio access technology that is utilized. Moreover, the number of transmission elements (e.g., antennas) comprising or utilized by the base station and the number of frequencies or nature carriers can differ depending on configuration of the radio access network.

The terminology “mobile station” refers generically to any wireless terminal in radio contact with such a base station, and can also bear other names such as (by way of non-limiting example) “wireless terminal”, “mobile terminal” or “user equipment unit (UE)” and, as such, encompasses, among other units, such devices as mobile telephones (“cellular” telephones) and laptops with wireless capability (e.g., mobile termination), and thus can be, for example, portable, pocket, hand-held, computer-included, or car-mounted mobile devices which communicate voice and/or data with radio access network.

The technology disclosed herein has particular applicability to a mobile station which operates either in whole or in part on a prepaid account basis. Accordingly, in view of total or partial utilization of prepaid account services or network, mobile station 30 may hereinafter be referred as a prepaid mobile station. Even when not so referenced the prepaid account operating nature of mobile station 30 is to be understood.

In view of the fact that mobile station 30 utilizes a prepaid account, FIG. 1 further illustrates charging system 40. The charging system 40 need not be dedicated to prepaid account activity per se, but can also be utilized for other types of accounts such as post-paid accounts, for example. While charging system 40 can be located within the radio access network that encompasses base station node 28, it is more typical for charging system 40 to be external to the radio access network and preferably to be at a node or service point of another network, such as a core network. The charging system 40 is usually maintained and/or operated by a service provider or network operator. As shown in FIG. 1, charging system 40 includes prepaid account ledger 42. The prepaid account ledger 42 typically includes a history of transactions for a prepaid account customer or user, such as the user of mobile station 30 of FIG. 1. While prepaid account ledger 42 includes files or histories for many consumers or users of prepaid account services, for sake of simplicity in the present discussion the prepaid account ledger 42 is described as hosting and maintaining the prepaid account transactional record(s) for the user or consumer of mobile station 30.

In order to maintain such prepaid account transactional record(s) the charging system 40 also includes transaction monitor/ledger updater 44. The transaction monitor/ledger updater 44 monitors or receives notifications regarding certain usages of a prepaid mobile station such as mobile station 30, and enters appropriate information reflecting such usage(s) into the prepaid account ledger 42 for the mobile station 30. For example, the transaction monitor/ledger updater 44 can receive call detail records (CDRs) or the like which are generated elsewhere and which reflect certain charge-related activities utilized or connection events experienced by mobile station 30. On the basis of information such as that provided by call detail records (CDRs) the transaction monitor/ledger updater 44 can make appropriate debit entries into prepaid account ledger 42 against the mobile station 30. On the other hand, when the consumer or user of mobile station 30 makes a payment to the service provider or network operator which serves as a financial deposit to initiate or replenish the prepaid account associated with mobile station 30, the transaction monitor/ledger updater 44 makes an appropriate credit entry to prepaid account ledger 42 for the mobile station 30.

As one aspect of the technology disclosed herein, the charging system 40 sends a report to mobile station 30 so that mobile station 30 can generate a visible display which is indicative of particular status of the prepaid account for mobile station 30. To this end charging system 40 also comprises a report generator, which in FIG. 1 is shown as scaled prepaid account report generator 46. FIG. 1 further shows (by an arrow) transmission of scaled prepaid account report 48 to mobile station 30. The scaled prepaid account report 48 can take varied forms (e.g., different types of messages) and have any suitable format. Transmission of the scaled prepaid account report 48 emanates from charging system 40, and can be routed through various nodes of a core network before reaching a radio access network. In the radio access network a base station such as base station node 28 transmits the scaled prepaid account report 48 over the interface 32 to mobile station 30. It will be appreciated that scaled prepaid account report 48 can be borne in different types of signals and/or bearers in the course of its travel from charging system 40 to mobile station 30.

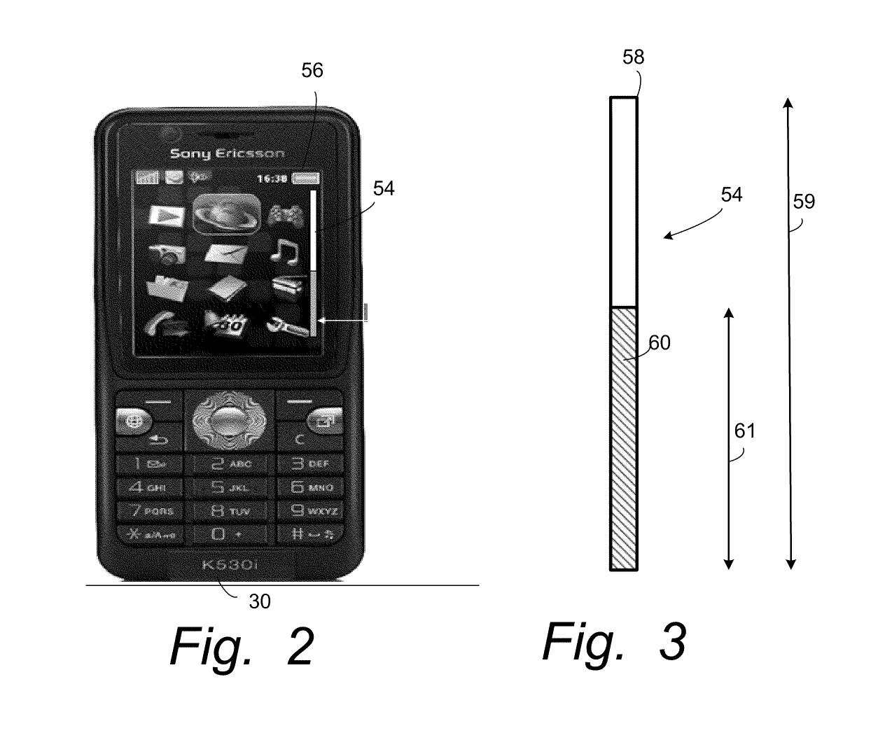

In general terms FIG. 2 shows mobile station 30 as comprising communications unit 49 and display unit 50. An example embodiment showing more details of communications unit 49 is subsequently described, but for implementation of the technology disclosed herein it is sufficient to know that communications unit 49 conducts the radio frequency reception and transmission operations and the signal and data handling for mobile station 30. In this regard, for sake of convenience the present description conceptualizes the information transmitted between base station node 28 and mobile station 30 as being in frames which comprise plural subframes, and that by mutually agreed scheduling between base station node 28 and mobile station 30 the scaled prepaid account report 48 is included in an appropriate portion of a frame. The inclusion of scaled prepaid account report 48 need not be in any particular format or even in a frame, but can occur in other ways in other embodiments.

At least some of the time communications unit 49 participates in transmission of data over radio interface 32 on a prepaid account basis. As used herein, the transmission of data on a prepaid account basis is to be understood as encompassing both transmission to and mobile station 30 from base station node 28 and transmission from mobile station 30 to base station node 28.

Display unit 50 comprises scaled prepaid account graphical depictor generator 52 which provides a unique prepaid account graphical depictor 54 on visual display unit 56. The visual display unit 56 can be, for example, a display screen (e.g., liquid crystal display screen or otherwise) of mobile station 30. FIG. 2 shows an example embodiment of mobile station 30 with visual display unit 56.

FIG. 3 provides an enlarged view of the prepaid account graphical depictor 54 of FIG. 2. From FIG. 3 it can be seen that prepaid account graphical depictor 54 comprises a perimeter-bounded graphical construct 58. In the example embodiment of

FIG. 3 the perimeter-bounded graphical construct 58 takes the form of a hollow rectangular bar that extends a vertical distance 59 shown in FIG. 3. In other embodiments the perimeter-bounded graphical construct 58 can take other polygonal or figural shapes. The perimeter-bounded graphical construct is at least partially graphically internally filled by a first graphical FIG. 60. In the example embodiment of FIG. 3 the first graphical FIG. 60 takes the form of a rectangular hatched bar which extends a vertical distance 61 in FIG. 3. In similar manner to perimeter-bounded graphical construct 58, the first graphical FIG. 60 can take other shapes or configurations. An extent of filling of the perimeter-bounded graphical construct 58 by the first graphical FIG. 60 occurs in proportion to a ratio of a prepaid account balance value for the consumer/user of mobile station 30 to a strategically chosen boundary value.

The prepaid account graphical depictor 54 (also shown in FIG. 2) is said to be unique in that, for example, it provides a visual indication of a prepaid account balance value for a prepaid account in scaled relation to the boundary value. The boundary value is other than and less than a maximum allowed prepaid account value or limit associated with the prepaid account for the consumer/user of mobile station 30.

The fact that the boundary value is other than and less than a maximum allowed prepaid account value is significant. Quite often the maximum allowed prepaid account value or limit is quite high, perhaps on the order of one thousand US dollars ($1,000 USD) or more. Yet in real world practice many customers do not fill their prepaid accounts to such a high maximum allowed prepaid account value or limit, or only maintain high account values for brief periods of time. Instead it is quite common for a consumer/user to have an account balance more on the order of, for example, $50 USD. Sometimes the balance may vary around a rather low amount as compared to the maximum allowed prepaid account value or limit. If a display such as the prepaid account graphical depictor 54 of FIG. 3 were operated to show current prepaid account balances hovering between $30 USD, $40 USD, or $50 USD, for example, in context of an overall maximum allowed prepaid account value or limit of $1,000 USD, the amount of the display depicting the current prepaid account balance would be quite small and any incremental changes would be essentially indistinguishable. For reasons such as these the technology disclosed herein provides its scaled prepaid account report 48 so that scaled prepaid account graphical depictor generator 52 of mobile station 30 can drive its visual display unit 56 in a manner such that presentation of the prepaid account balance depicted by prepaid account graphical depictor 54 is palpable and changes in the prepaid account balance are perceptible.

Thus, the boundary value that is utilized for generating the prepaid account graphical depictor 54 is strategically chosen to be other than and less than the maximum allowed prepaid account value or limit. In differing embodiments or differing operational modes of the same embodiment the boundary value can be, for example, a latest refill value for the prepaid account; an account status/balance at refill occasion value for the prepaid account; or a configured value for the prepaid account.

Several possible/candidate boundary values have just been mentioned. Of these, the latest refill value for the prepaid account is understood to be the amount of the most recent deposit or credit or payment made by the consumer or user or on his/her behalf for initiating or replenishing the prepaid account. For example, the latest refill value may be a payment of $60 USD, which could bring the current prepaid account balance up to $100 USD, for example. In this situation, rather than showing the filling as being only one tenth of prepaid account graphical depictor 54 (assuming that $100 USD is one tenth of a maximum allowed prepaid account value or limit of $1,000 UDS), the internal filling of prepaid account graphical depictor 54 would be entire. Subsequently, when the prepaid account balance for the prepaid account for mobile station 30 decreases to $30 USD, the internal filling of prepaid account graphical depictor 54 would be half (since the prepaid account balance of $30 USD is half the latest refill value of $60 USD).

If the boundary value is chosen to represent the account status/balance at refill occasion value, the prepaid account balance is graphically depicted relative to the account status/balance that occurred at the time of the most recent refill (the actual account balance immediately following the last credit or payment). As in the scenario of the preceding paragraph, at the time of refill the internal filling of prepaid account graphical depictor 54 would be entire. But when the prepaid account balance for the prepaid account for mobile station 30 decreases to $30 USD, the internal filling of prepaid account graphical depictor 54 would be thirty percent (since the prepaid account balance of $30 USD is now thirty percent of the $100 USD balance that resulted at the latest refill value of $60 USD).

Alternatively the boundary value can be chosen to be another number such as a static number which has significance either to the consumer/user of mobile station 30 or the charging system 40, e.g., the aforementioned configured value for the prepaid account. Such configured value can be useful, for example, if the consumer/user is mindful of a financial budget and wants to prorate service use over a budget amount that is represented by the configured boundary value. The configured value can be set in any one or more of a variety of ways. For example, the configured value can be set by a user (e.g., the consumer/user of mobile station 30); by a master subscriber (e.g., by an account owner, who may own (for example) a family accounts of which this prepaid account is just one); or by charging system 40 (e.g., by the system owner or network operator). For example, the case of “account owner” is applicable for e.g. shared account where a family member, e.g., child (user account) is given a (monthly) limit from the parents account (master subscriber being account owner). In the cases of the configured value being set by the user or master subscriber, the configured value may be set through interaction with the charging system 40 via any suitable mechanism, such as Internet communications to an account webpage or through a special call (preferably password protected) using the mobile station 30.

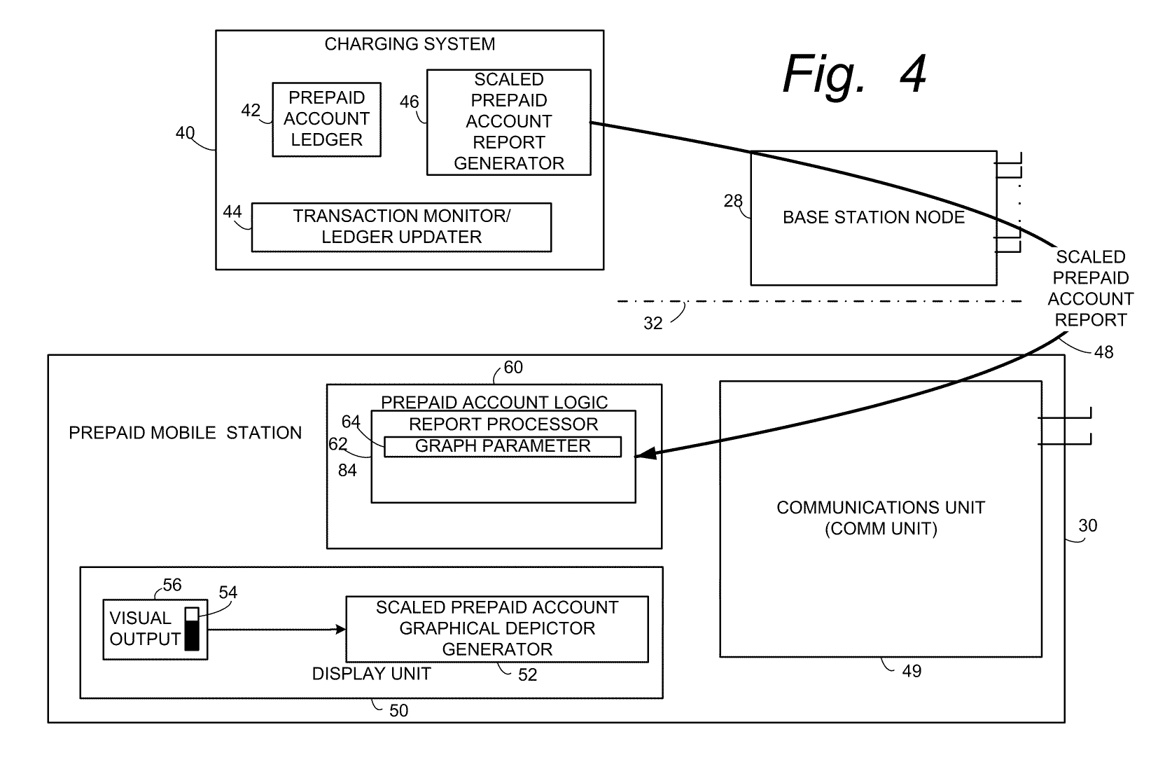

FIG. 4 shows an example embodiment wherein mobile station 30 further comprises prepaid account logic unit 60. The prepaid account logic unit 60 is illustrated as further comprising report processor 62 which utilizes a reported graphical parameter 64. After receipt by communications unit 49, the scaled prepaid account report 48 is examined and processed by report processor 62. The report processor 62 is particularly interested in the graphical parameter 64 which can be interpreted to understand a ratio or proportion of the prepaid account balance to the boundary value which is chosen for utilization. That is, the graphical parameter 64 which expresses a relation of the prepaid account balance to the boundary value. Display of the prepaid account graphical depictor 54 on visual display unit 56 is dependent on the graphical parameter 64. The graphical parameter 64 can be provided by the charging system 40. Alternatively, the account report generator may provide the account balance and the boundary value so that the graphical parameter 64 can be calculated in the mobile station 30). In the special case of the preconfigured boundary value the graphical parameter 64 can alternatively be stored locally in the mobile station 30 and needs never to be known by the charging system 40 or delivered from the charging system 40 to the mobile station 30 (e.g., the graphical parameter 64 is stored in a fill level application or the like at the mobile station 30).

From one vantage point the prepaid account graphical depictor 54 can be conceptualized as a graph. In such case, the scale on the graph symbolizes the account status. As explained above, the full or maximum size of the prepaid account graphical depictor 54 (its boundary shape) can represent any one of three different quantities. Those three different value definitions (the boundary value) which represent “full” on the graph can be either the latest refill value; the account status at refill occasion; or a static value (e.g. $200 USD) configurable by operator or consumer. Empty in the graph is generally zero.

At the end of any charging event the charging system 40 sends the scaled prepaid account report 48 to prepaid account logic unit 60. In some embodiments the scaled prepaid account report 48 includes the graphical parameter 64 and preferably the prepaid account balance (i.e., the current account value) as well. In the ensuing examples the graphical parameter 64 (GraphParameter), having values between 1.00 to 0.00, is used to display the graph in a linear scale.

In a mode in which the boundary value is the latest refill value, the graphical parameter 64 can be computed in accordance with Expression 1.

prepaid account balance/Refill value=GraphParameter Expression 1

If GraphParameter=or >1.00; the prepaid account graphical depictor 54 of prepaid account logic unit 60 indicates “full value”. On the other hand, if GraphParameter=0.00, the prepaid account graphical depictor 54 indicates “empty value”.

In a mode in which the boundary value is account status at refill occasion, the graphical parameter 64 can be computed in accordance with Expression 2.

prepaid account balance/Account value at refill occasion=GraphParameter Expression 2

If GraphParameter=1, the prepaid account graphical depictor 54 of prepaid account logic unit 60 indicates “full value”. On the extreme, if GraphParameter=0, the prepaid account graphical depictor 54 indicates “empty value”.

In a mode in which the boundary value is a static value, the graphical parameter 64 is computed in accordance with Expression 3.

prepaid account balance/Static Value=GraphParameter Expression 3

If GraphParameter=or 22 1, the prepaid account graphical depictor 54 of prepaid account logic unit 60 indicates “full value”. At the other extreme, if GraphParameter=0, the prepaid account graphical depictor 54 indicates “empty value”.

In some example embodiments the visual display unit 56 is also capable of providing an alphanumeric representation of the prepaid account balance value when user interaction occurs proximate the prepaid account graphical depictor. That is, the prepaid account balance that is included in the scaled prepaid account report 48 can be stored by prepaid account logic unit 60 and can be displayed when the user performs an operation such as a double click on or near the graph, e.g., prepaid account graphical depictor 54.

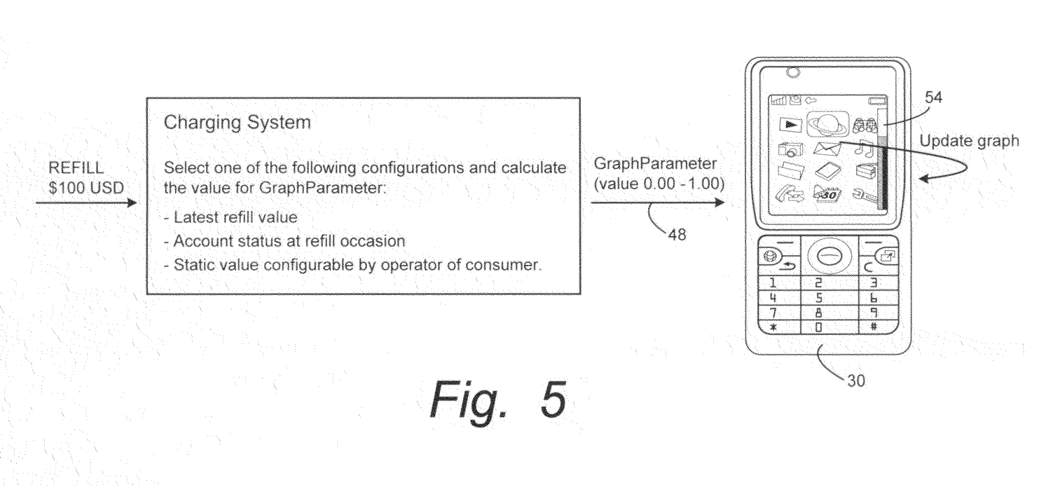

As illustrated in FIG. 5, ordinarily the scaled prepaid account report generator 46 is programmed with, or programmed to select between, one of plural candidate value types to be used in the scaled prepaid account report 48 as the boundary value. As mentioned above, the plural candidate value types include a latest refill value for the prepaid account; an account status/balance at refill occasion value for the prepaid account; and a configured value for the prepaid account.

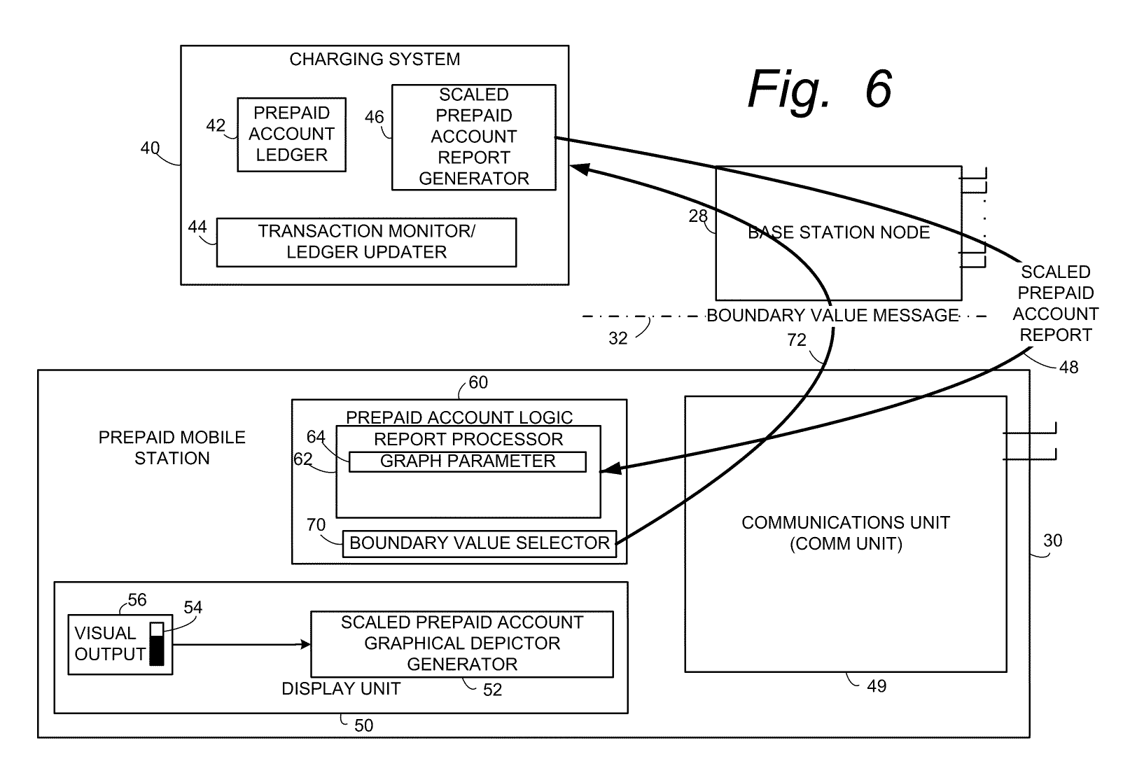

In another aspect of the technology disclosed herein and in some example embodiments such as that represented by FIG. 6, the customer or user of mobile station 30 can select or configure which of plural possible boundary criteria is actually to be used for the aforementioned boundary value. For example, the consumer/user of mobile station 30 can select whether the boundary value is to be either (1) a latest refill value for the prepaid account; (2) an account status/balance at refill occasion value for the prepaid account; and (3) a configured value for the prepaid account. In such case and as shown by FIG. 6, the scaled prepaid account report generator 46 is configured to select between one of plural candidate value types on the basis of a directive message received from the prepaid mobile station.

To provide consumer/user selection the prepaid account logic unit 60 of FIG. 6 further comprises boundary value selector 70. The boundary value selector 70 serves to request that the scaled prepaid account report 48 be configured to include the graphical parameter 64 in the manner specified by boundary value selector 70. FIG. 6 thus shows boundary value selection directive or message 72 sent from prepaid account logic unit 60 of mobile station 30 to charging system 40. The boundary value selection directive 72 includes an indication of which of the plural candidate boundary values is selected at mobile station 30 for use in the scaled prepaid account report 48 for use in display by prepaid account graphical depictor 54. It will be appreciated that the boundary value selection directive 72 need not be a special or dedicated message, but can be an information element or signal included in a frame or other packet of data/signaling sent from mobile station 30 over the interface 32.

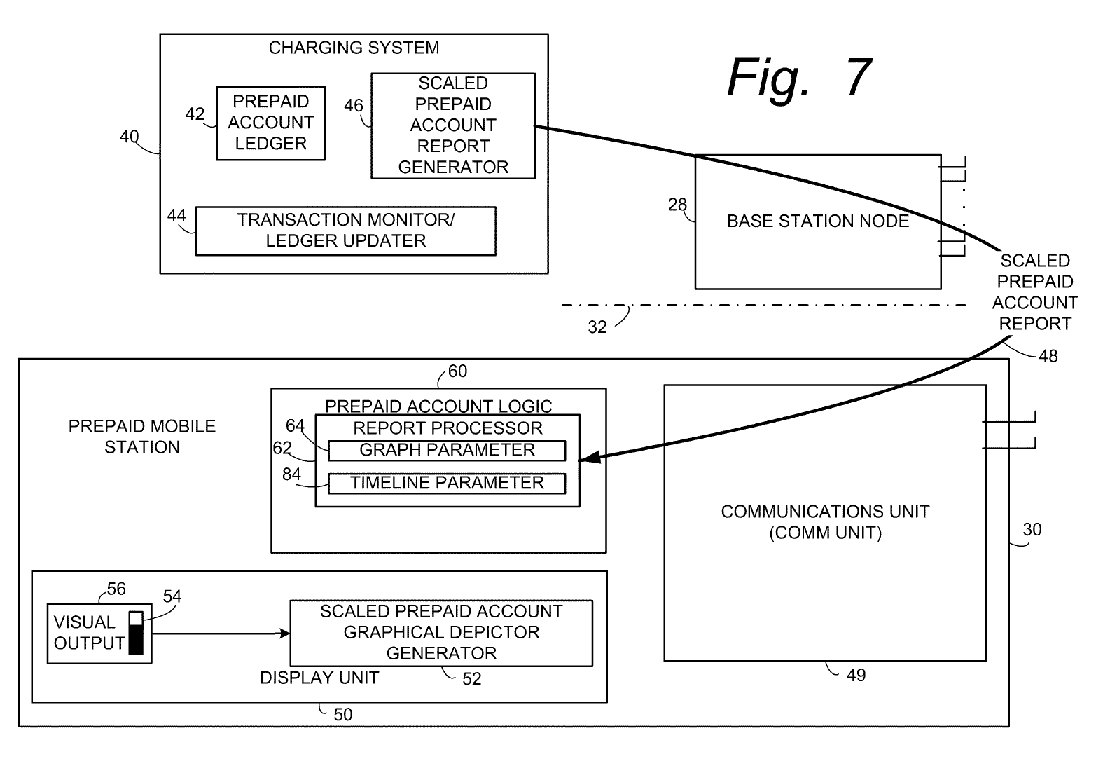

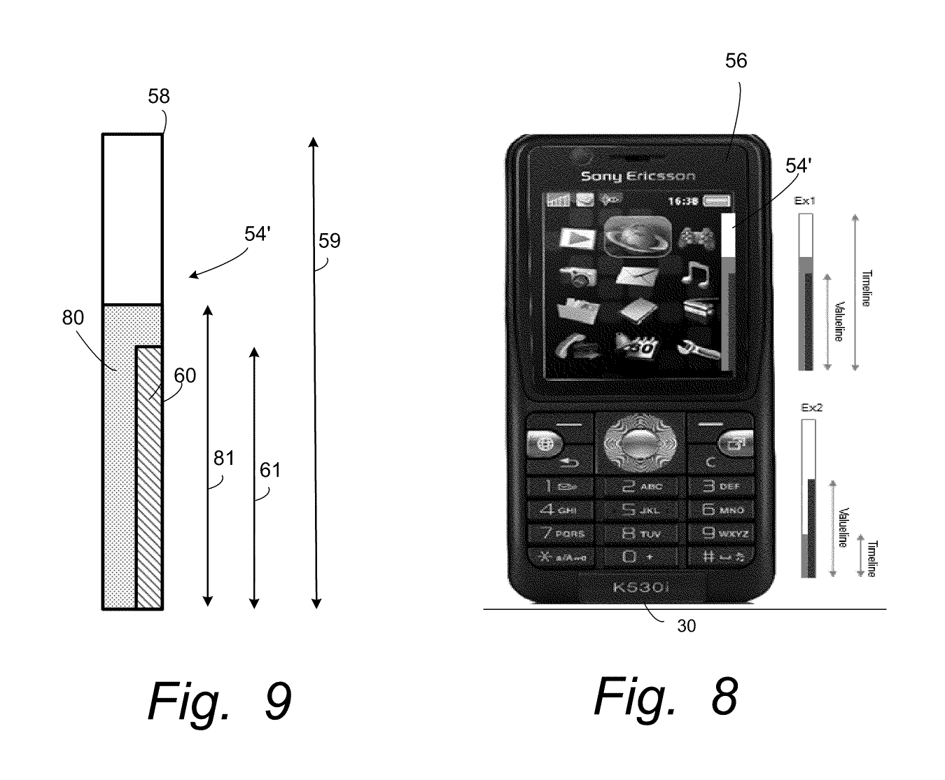

In yet another example embodiment illustrated by FIG. 7 in conjunction with FIG. 8 and FIG. 9, the prepaid account graphical depictor takes the form of an extended graph icon which has the capacity and capability of indicating an account value for prepaid accounts that have time limits, for example campaigns or special time-limited offers or services. In this regard, FIG. 8 shows the visual display unit 56 of mobile station 30 as having an enhanced prepaid account graphical depictor 54′. As shown in more detail in FIG. 9, prepaid account graphical depictor 54′ of FIG. 8 not only internally accommodates the first graphical FIG. 60 (see FIG. 3), but also internally accommodates second graphical FIG. 80. Whereas the first graphical FIG. 60 (shown with hatched fill in FIG. 9) symbolizes an account value (e.g., the prepaid account balance), the second graphical FIG. 80 (shown by stippled or dotted fill in FIG. 9) symbolizes a time period and particularly a percentage of time remaining in a time period. In the example embodiment of FIG. 9 the second graphical FIG. 80 takes the form of a rectangular stippled bar which extends a vertical distance 81 in FIG. 9. In similar manner as discussed previously, the second graphical FIG. 80 can take other shapes or configurations. An extent of filling of the perimeter-bounded graphical construct 58 by the second graphical FIG. 80 occurs in proportion to a ratio of time remaining (in a time period for the consumer/user of mobile station 30 to use a particular service or network) to the maximum time duration of the time period. For example, at the beginning of a campaign there is no white area in perimeter-bounded graphical construct 58 as second graphical FIG. 80 entirely fills perimeter-bounded graphical construct 58, but as time goes the white area extends as second graphical FIG. 80 diminishes. For example, if the duration of a campaign is 4 weeks, the white within perimeter-bounded graphical construct 58 and second graphical FIG. 80 will be equal after two weeks. Thus, an extent of filling of the perimeter-bounded graphical construct 58 by the second graphical FIG. 80 is in proportion to a ratio of an unexpired time value to a total time value associated with the prepaid account.

For the embodiment of FIG. 7, FIG. 8, and FIG. 9, the scaled prepaid account report generator 46 is configured to include a timeline parameter 84 in the scaled prepaid account report 48. FIG. 7 shows prepaid account logic unit 60 as receiving the timeline parameter 84. In an example embodiment the scaled prepaid account report generator 46 can generate the timeline parameter 84 (TimeParameter) in accordance with Expression 4.

Offer_time_left/Offer_duration=TimeParameter Expression 4

If TimeParameter=1, the prepaid account graphical depictor 54′ of prepaid account logic unit 60 indicates time at “full value”. At the other extreme, if TimeParameter=0, the prepaid account graphical depictor 54′ indicates an “empty value”. The TimeParameter (values between 1.00 to 0.00) can thus used to display the graph in a linear scale.

At end of any charging event to the prepaid account, the scaled prepaid account report generator 46 sends the timeline parameter 84 in a scaled prepaid account report 48, and optionally the value of a parameter Offer_time_left (in some embodiments along with the graphical parameter 64 and/or the prepaid account balance). The values of TimeParameter and Offer_time_left are stored by prepaid account logic unit 60. The parameter offer_time_left value can be stored on client to view the information by, e.g., by a double click on the graph.

The charging system 40 can use any one of several possible interfaces to send its scaled prepaid account report 48 (including account and offer information, both value range and timelines) to mobile station 30. For example, the scaled prepaid account report 48 can be sent as Unstructured Supplemental Service Data (USSD) requests which send end of call notification and which update the scaled prepaid account report generator 46 so that the prepaid account graphical depictor 54 or 54′ can be displayed. In such case the USSD text message can be encoded to differentiate from an ordinary USSD messages.

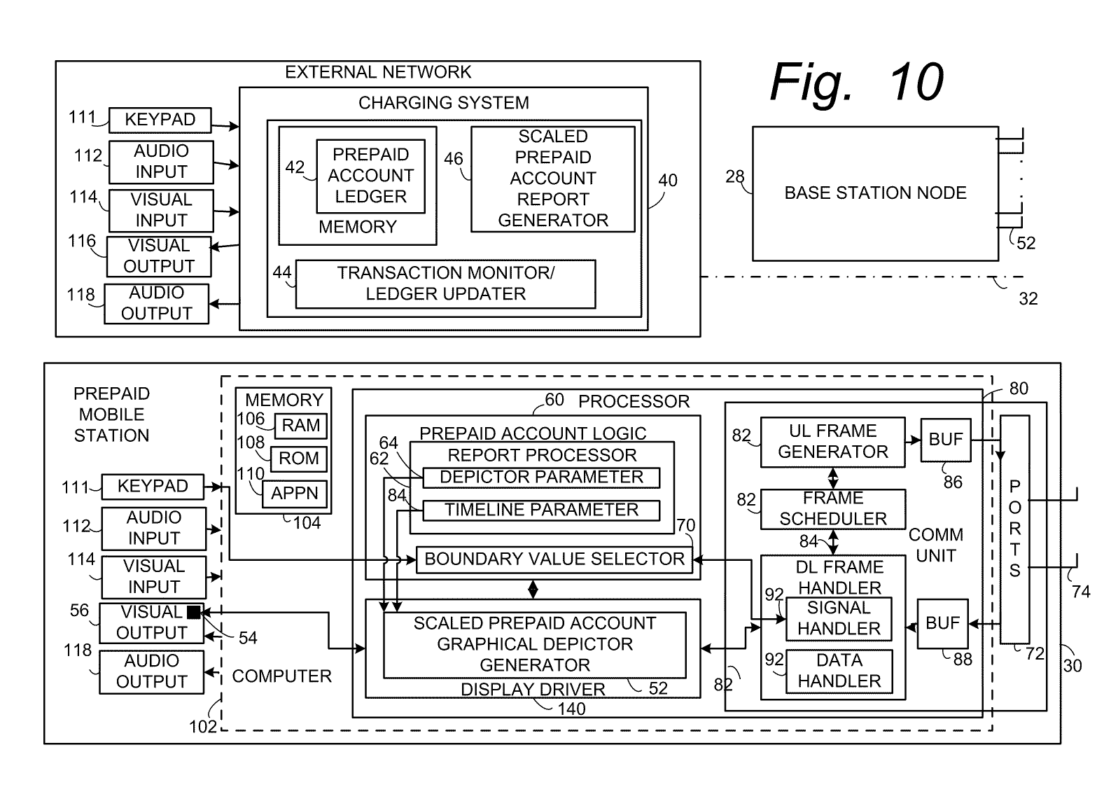

FIG. 10 illustrates more structural detail for certain example embodiments of charging system 40 and mobile station 30. For example FIG. 10 illustrates that charging system 40 can be provided on a machine platform 90. The machine platform 90 can take any of several forms, such as (for example) a computer implementation platform or a hardware circuit platform. FIG. 10 particularly shows machine platform 90 as being a computer platform wherein logic and functionalities of charging system 40 are implemented by one or more computer processors or controllers as those terms are herein expansively defined. In conjunction with the computer platform FIG. 10 shows charging system 40 as including various interfaces, among which are keypad 111; audio input device (e.g. microphone) 112; visual input device (e.g., camera) 114; visual output device (e.g., display 116); and audio output device (e.g., speaker) 118. Other types of input/output devices can also be connected to or comprise charging system 40.

FIG. 10 likewise shows mobile station 30 as being realized, at least in part, by machine platform 120. FIG. 10 also shows selected, representative components and/or functionalities of communications unit 49. Among the illustrated components of communications unit 49 are communication port(s) 122 which connect to the one or more transmission element(s) 124 of mobile station 30. Since the communications unit 49 participates in both uplink and downlink transmissions over interface 32, communications unit 49 further comprises both downlink buffer 126 and uplink (UL) buffer 128. Frames or data or signals received in and stored in downlink buffer 126 are processed by downlink frame handler 130, which includes both signal handler 132 and data handler 134. The communications unit 49 further comprises uplink (UL) frame generator 136 which generates frames which are stored in buffer 128 prior to application to ports 122. The operation of uplink (UL) frame generator 136 and downlink frame handler 130 are controlled and synchronized by frame scheduler 138, which is also synchronized with base station node 28.

The scaled prepaid account graphical depictor generator 52 of FIG. 1 is, in the example implementation of FIG. 10, hosted by display driver 140. The display driver 140 connects to visual display unit 56, which is just one of several input/output units available to and/or connected to mobile station 30.

Various functional units of mobile station 30 are provided on the aforemention platform 120 which is framed by broken lines in FIG. 10. The terminology “platform” is a way of describing how the functional units of mobile station 30 can be implemented or realized by machine One example platform 120 is a computer implementation wherein one or more of the framed elements, including prepaid account logic unit 60 and display driver 140, are realized by one or more processors which execute coded instructions in order to perform the various acts described herein. In such a computer implementation the mobile station 30 can comprise, in addition to a processor(s), memory section 134 (which in turn can comprise random access memory 136; read only memory 138; application memory 140 (which stores, e.g., coded instructions which can be executed by the processor to perform acts described herein); and any other memory such as cache memory, for example).

Typically the mobile station 30 also comprises other input/output units or functionalities, the representative input/output units for mobile station 30 being illustrated in FIG. 10 as keypad 141; audio input device (e.g. microphone) 142; visual input device (e.g., camera) 144; the aforementioned visual output device (e.g., visual display unit 56); and audio output device (e.g., speaker) 148. Other types of input/output devices can also be connected to or comprise mobile station 30.

In the example of FIG. 10 the platforms 90 and 120 have been illustrated as computer-implemented or computer-based platforms. Another example platform suitable for mobile station 30 or charging system 40 is that of a hardware circuit, e.g., an application specific integrated circuit (ASIC) wherein circuit elements are structured and operated to perform the various acts described herein

Thus, in an example embodiment the technology disclosed herein enables use of a prepaid account graphical depictor 54 (such as a simple bar icon similar to that for displaying degree of battery charge) to indicate status of a prepaid account. In an alternate embodiment, an extended or enhanced prepaid account graphical depictor 54 can be used to indicate a timeline if an account/value has a limited time period. This enhancement gives the consumer an immediate perception of the account status. In an example embodiment, it is also possible to get more details by a simple button click (to obtain an alphanumeric representation of the prepaid account balance).

The technology disclosed herein also advantageously enhances the visual appearance on the mobile phone improves viewing of prepaid account information. Moreover, the enhanced appearance and readily available information may tend to increase traffic as the user is always aware of the account status, thus resulting in more business for the network operator. Moreover, the technology disclosed herein has a further advantage of likelihood of reduction of number of calls to customer service offices or the like for service providers or network operators since the customers have ready and reliable information for immediate and easily perceptible viewing

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. A mobile station comprising:
a communications unit configured to participate in transmission of data over a radio interface on a prepaid account basis;
a display unit configured to provide a prepaid account graphical depictor, the prepaid account graphical depictor providing an indication of a prepaid account balance value for a prepaid account in scaled relation to a boundary value, the boundary value being other than and less than a maximum allowed prepaid account value.

2. The mobile station of claim 1, wherein the boundary value represents a latest refill value for the prepaid account.

3. The mobile station of claim 1, wherein the boundary value represents an account status/balance at refill occasion value for the prepaid account.

4. The mobile station of claim 1, wherein the boundary value represents a configured value for the prepaid account.

5. The mobile station of claim 4, wherein the configured value is set by a user; by a master subscriber; or by a charging system.

6. The mobile station of claim 1, wherein the depictor comprises a perimeter-bounded graphical construct, a perimeter of the perimeter-bounded graphical construct representing the boundary value, the perimeter-bounded graphical construct being at least partially graphically internally filled by a first graphical figure, an extent of filling of the perimeter-bounded graphical construct by the first graphical figure being in proportion to a ratio of the prepaid account balance value to the boundary value.

7. The mobile station of claim 6, wherein the perimeter-bounded graphical construct is at least partially graphically internally filled by a second graphical figure, an extent of filling of the perimeter-bounded graphical construct by the second graphical figure being in proportion to a ratio of a unexpired time value to a total time value associated with the prepaid account.

8. The mobile station of claim 1, further comprising a prepaid logic unit, the prepaid logic unit comprising:
a report processor arranged to receive a report which includes a graphical parameter which expresses a relation of the prepaid account balance to the boundary value;
wherein display of the prepaid account graphical depictor on the display unit is dependent on the graphical parameter;
a boundary value selector arranged to prepare a directive message for a charging system, the directive message being arranged to specify one of plural candidate value types to be used in the report by the charging system for preparing the graphical parameter.

9. The mobile station of claim 8, wherein the plural candidate value types include a latest refill value for the prepaid account; an account status/balance at refill occasion value for the prepaid account; and a configured value for the prepaid account.

10. The mobile station of claim 1, wherein the display unit is configured to provide an alphanumeric representation of the prepaid account balance value when user interaction occurs proximate the prepaid account graphical depictor.

11. A charging unit which manages financial transactions for a prepaid mobile station, the charging unit comprising:
an account ledger which maintains a prepaid account balance value for a prepaid account for the prepaid mobile station;
a prepaid account report generator configured to provide the prepaid mobile station with a graphical parameter, the graphical parameter being configured to express a relation of the prepaid account balance to a boundary value to enable the prepaid mobile station to generate a prepaid account graphical depictor on a display of the prepaid mobile station so that the prepaid account graphical depictor illustrates the prepaid account balance value in scaled relation to the boundary value, the boundary value being other than and less than a maximum allowed prepaid account value for the prepaid mobile station.

12. The charging unit of claim 11, wherein the boundary value represents a latest refill value for the prepaid account.

13. The charging unit of claim 11, wherein the boundary value represents an account status/balance at refill occasion value for the prepaid account.

14. The charging unit of claim 11, wherein the boundary value represents a configured value for the prepaid account.

15. The charging unit of claim 14, wherein the configured value is set by a user; by a master subscriber; or by the charging unit.

16. The charging unit of claim 11, wherein the prepaid account report generator is configured to select between one of plural candidate value types to be used in the report by the charging system for the boundary value.

17. The charging unit of claim 16, wherein the plural candidate value types include a latest refill value for the prepaid account; an account status/balance at refill occasion value for the prepaid account; and a configured value for the prepaid account.

18. The charging unit of claim 16, wherein the prepaid account report generator is configured to select between one of plural candidate value types on the basis of a directive message received from the prepaid mobile station.

19. The charging unit of claim 11, wherein the prepaid account report generator is further configured to provide the prepaid mobile station with a time parameter, the time parameter being configured whereby the prepaid mobile station can also use the prepaid account graphical depictor to express a relation of an unexpired time value for the prepaid account to a total time value associated with the prepaid account.

20. A method of managing a prepaid account for a prepaid mobile station, the method comprising:
a charging system external to the prepaid mobile station providing to the prepaid mobile station over a radio interface a graphical parameter, the graphical parameter being configured to express a relation of a prepaid account balance for the prepaid account for the prepaid mobile station to a boundary value;
the prepaid mobile station receiving and using the graphical parameter to generate a prepaid account graphical depictor on a display of the prepaid mobile station so that the prepaid account graphical depictor illustrates the prepaid account balance value in scaled relation to the boundary value, the boundary value being other than and less than a maximum allowed prepaid account value for the prepaid mobile station.

21. The method of claim 20, wherein the boundary value represents a latest refill value for the prepaid account.

22. The method of claim 20, wherein the boundary value represents an account status/balance at refill occasion value for the prepaid account.

23. The method of claim 20, wherein the boundary value represents a configured value for the prepaid account.

24. The method of claim 23, wherein the configured value is set by a user; by a master subscriber; or by a charging system

25. The method of claim 20, further comprising specifying one of plural candidate value types to be used in the report by the charging system for preparing the graphical parameter.

26. The method of claim 25, wherein the plural candidate value types include a latest refill value for the prepaid account; an account status/balance at refill occasion value for the prepaid account; and a configured value for the prepaid account.

27. The method of claim 20, further comprising providing the prepaid mobile station with a time parameter, the time parameter being configured whereby the prepaid account graphical depictor can also be used to express a relation of an unexpired time value for the prepaid account to a total time value associated with the prepaid account.
